(19) United States
(12) Patent Application Publication
(10) Pub. No.: US 2024/0415134 A1
(43) Pub. Date: Dec. 19, 2024

(54) METHODS FOR REDUCED-MEDICINE TREATMENT FOR POST-HARVEST PRESERVATION OF BAYBERRIES

(71) Applicant: ZHEJIANG UNIVERSITY ZHONGYUAN INSTITUTE, Zhengzhou, Henan (CN)

(72) Inventors: Di WU, Hangzhou (CN); Dandan ZHENG, Hangzhou (CN); Chongde SUN, Hangzhou (CN); Kunsong CHEN, Hangzhou (CN)

(73) Assignee: ZHEJIANG UNIVERSITY ZHONGYUAN INSTITUTE, Zhengzhou, Henan (CN)

(21) Appl. No.: 18/725,752

(22) PCT Filed: Oct. 8, 2022
(86) PCT No.: PCT/CN2022/123785

§ 371 Date: Jun. 28, 2024

(30) Foreign Application Priority Data
Dec. 30, 2021 (CN) 202111651921.0

(51) Int. Cl. A23B 7/154; A23B 7/015

(52) U.S. Cl. CPC A23B 7/154; A23B 7/015

(57) ABSTRACT

Embodiments of the present disclosure provide a method for reduced-medicine treatment for post-harvest preservation of bayberries. The method includes: (1) packing after picking: placing ripe bayberries into a skeletonized injection-molded package after picking, the bayberries being spaced apart and evenly arranged in the skeletonized injection-molded package; (2) low-concentration peroxyacetic acid solution treatment: spraying a peroxyacetic acid solution with a concentration of 0.1% onto a surface of the bayberries; and (3) atmospheric plasma treatment: performing an atmospheric plasma treatment on the bayberries treated with the peroxyacetic acid solution for 5 minutes, and temporarily storing the bayberries in a refrigerated warehouse at 4° C. after the treatment. By combining peroxyacetic acid with atmospheric plasma, an amount of peroxyacetic acid solution used can be effectively reduced and efficacy of the treatment can be increased.

### TECHNICAL FIELD

The present disclosure relates to the field of preservation of agricultural products, and in particular, to a method for reduced-medicine treatment for post-harvest preservation of bayberries.

### BACKGROUND

Bayberry, also known as yangmei, is a subtropical fruit native to China, predominantly cultivated in the eastern and southern regions of the country. The fruit is notable for its high water content and rich nutritional profile, featuring an appealing range of colors from red to purple and a distinctive, enticing flavor. Additionally, bayberry boasts a substantial quantity of antioxidants, including anthocyanins, flavonoids, and other phenolic compounds, which helps inhibit the oxidation of low-density lipoproteins and lipids in the human body.

Bayberries typically ripen during the hot and rainy season. Once harvested, they are highly prone to microbial contamination and spoilage, particularly if they are mechanically damaged, which greatly reduces their shelf life. Bayberries are characterized by seasonality and regionality, which makes long-term storage challenging and transportation to northern regions difficult, thus restricting their edible period and sales range.

Therefore, finding cost-efficacyive, efficient, and pollution-free preservation techniques for bayberries has become crucial for sustainable development of a bayberry industry.

Widely regarded as an efficacyive sterilization method, non-thermal plasma is an ionized gas consisting of charged particles, an electric field, ultraviolet photons, and reactive species. Among these, reactive oxygen species (ROS) are seen as key agents in plasma inactivation.

Peroxyacetic acid (PAA) displays broad-spectrum antimicrobial activity even at low concentrations, exhibiting potent bactericidal, virucidal, fungicidal, and sporicidal efficacy. It remains effective even with brief exposure and is largely independent of temperature and pH variations, as well as being virtually unaffected by protein residues.

At the room temperature, peroxyacetic acid is stable, minimally affected by organic matter, leaves no toxic residues, and is reasonably priced and easy to use. After application, peroxyacetic acid rapidly decomposes into oxygen, acetic acid, and water-substances that are quickly metabolized by microorganisms, resulting in minimal environmental impact. The commonly used concentration of peroxyacetic acid in production is 0.5%, but lower concentrations improve safety. Therefore, finding ways to reduce the amount of preservatives used in post-harvest preservation of bayberries has become an urgent issue.

### SUMMARY

The present disclosure aims to provide a method for reduced-medicine treatment for post-harvest preservation of bayberries, in which a peroxyacetic acid solution is used in conjunction with atmospheric plasma, thereby effectively reducing an amount of the peroxyacetic acid solution used and enhancing the efficacy of the treatment.

The technical solution adopted by the present disclosure to solve the technical problems includes: the method for reduced-medicine treatment for post-harvest preservation of bayberries, including:
(1) packing after picking: placing ripe bayberries into a skeletonized injection-molded package after picking, the bayberries being spaced apart and evenly arranged in the skeletonized injection-molded package;
(2) low-concentration peroxyacetic acid solution treatment: spraying a peroxyacetic acid solution with a concentration of 0.1% onto a surface of the bayberries; and
(3) atmospheric plasma treatment: performing an atmospheric plasma treatment on the bayberries treated with the peroxyacetic acid solution for 5 minutes, and temporarily storing the bayberries in a refrigerated warehouse at 4° C. after the treatment.

In some embodiments, in step (2), the bayberries are sprayed with the peroxyacetic acid solution for a total of 6 times, once each from above, below, front, behind, left, and right of the bayberries, respectively.

In some embodiments, in step (3), the atmospheric plasma is produced by injecting air as a working gas with a gas flow rate of 1.05 m³/min into an electrode tube to generate plasma in a discharge gap of 0.3 mm.

In some embodiments, in step (3), the atmospheric plasma treatment includes alternately delivering atmospheric plasma under a room temperature condition and atmospheric plasma after a cryogenic treatment, specifically, delivering the atmospheric plasma after the cryogenic treatment in a first minute, delivering the atmospheric plasma under the room temperature condition in a second minute, delivering the atmospheric plasma after the cryogenic treatment in a third minute, delivering the atmospheric plasma under the room temperature condition in a fourth minute, and delivering the atmospheric plasma after the cryogenic treatment in a fifth minute; and the atmospheric plasma after the cryogenic treatment is obtained from atmospheric plasma cooled by an ice-water mixture.

Conventional atmospheric plasma treatment of bayberries presents a problem: when air is excited to form plasma, the temperature rises. A plasma airflow, when transported through pipelines at room temperature, can reach the bayberries at a temperature as high as 40° C. While such high-temperature plasma airflow has good sterilization effects, it can still cause the fruit pulp to deteriorate. Conversely, if the temperature is lowered, the plasma becomes less active, leading to suboptimal sterilization. Therefore, to address the shortcomings of conventional atmospheric plasma treatment of bayberries, the present disclosure improves the method by alternately delivering plasma at the room temperature and plasma after the cryogenic treatment. When plasma is delivered at the room temperature, the temperature of the plasma airflow is about 40° C., ensuring good sterilization. At the same time, to reduce the impact of high temperature on the quality of the fruit pulp, plasma is also delivered after the cryogenic treatment. Although the sterilization effect is weakened at lower temperatures, the impact on the quality of the fruit pulp is minimized, thus balancing both sterilization efficacy and quality assurance. Additionally, using the process for alternately delivering the plasma under the room temperature condition and the plasma after the cryogenic treatment, the present disclosure must be ensured that the last time is to deliver plasma after low-temperature treatment. This is because, after the atmospheric plasma treatment, the bayberries need to be stored in the refrigerated warehouse. If the treatment ends with plasma at about 40° C., the fruit pulp is susceptible to quality and taste damage, including frostbite, due to the significant temperature difference. By ensuring that the final plasma treatment is at a lower temperature, the temperature difference with refrigeration is minimized, better preserving the quality and taste of the bayberries. The process for alternately delivering the plasma under the room temperature condition and the plasma after the cryogenic treatment involves short intervals, which can prevent drastic fluctuations in the fruit's temperature.

The beneficial effect of the present disclosure includes that: by combining peroxyacetic acid with atmospheric plasma, the amount of the peroxyacetic acid used can be effectively reduced and the efficacy of the treatment can be increased.

### BRIEF DESCRIPTION OF THE DRAWINGS

FIG. 1 is a schematic diagram of a structure of the present disclosure.

### DETAILED DESCRIPTION

The technical solution of the present disclosure is further described in detail below through specific embodiments.

In the present disclosure, unless otherwise specified, the raw materials and equipment used can be purchased from the market or are commonly used in the field. The methods in the following embodiments, unless otherwise specified, are conventional methods in the field.

### Embodiment 1

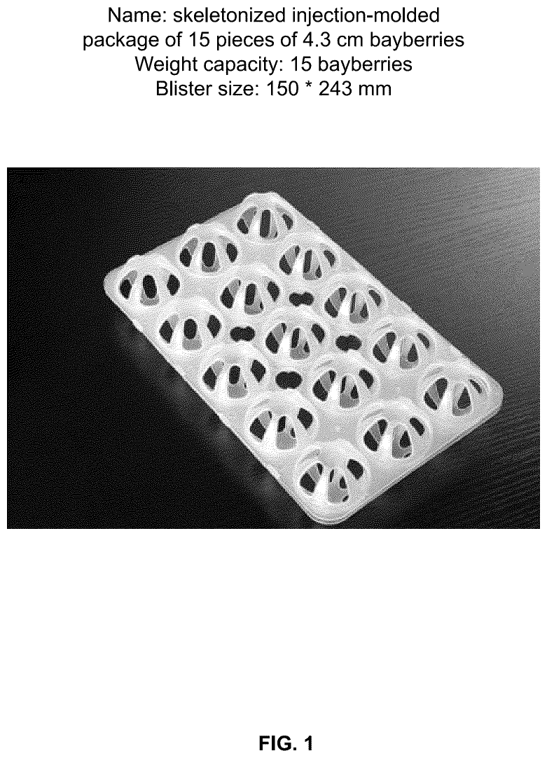

A method for reduced-medicine treatment for post-harvest preservation of bayberries, may include:
(1) packing after picking: placing ripe bayberries into a skeletonized injection-molded package after picking, the bayberries being spaced apart and evenly arranged in the skeletonized injection-molded package. The skeletonized injection-molded package is shown in FIG. 1.
(2) low-concentration peroxyacetic acid solution treatment: spraying a peroxyacetic acid solution with a concentration of 0.1% onto a surface of the bayberries for a total of 6 times, once each from above, below, front, behind, left, and right of the bayberries, respectively.
(3) atmospheric plasma treatment: performing an atmospheric plasma treatment on the bayberries treated with the peroxyacetic acid solution for 5 minutes, and temporarily storing the bayberries in a refrigerated warehouse at 4° C. after the treatment. An atmospheric plasma system may include a function generator (Nanjing Suman Electronics Co., Ltd., China), a chamber, and an AC power supply (CTP 2000 K, Nanjing Suman Electronics Co., Ltd., China). The function generator may include nine electrode tubes. Each electrode tube may be a hollow structure including an inner stainless steel electrode and an outer quartz electrode. A high voltage (up to 30 KV) generated by the AC power supply (220 V, 50 Hz) may be coupled to the electrodes. The chamber measures 30×25×15 cm, is made of polypropylene and is tightly sealed. The atmospheric plasma system may generate plasma with a dielectric barrier discharge (DBD) technology. Air may be used as a working gas and injected into the electrode tubes with a flow rate of 1.05 m³/min. The plasma may be generated in the electrode tubes with the discharge gap of 0.3 millimeters and is then transported to the chamber for treatment. The alternately delivering an atmospheric plasma under a room temperature condition and an atmospheric plasma after a cryogenic treatment may include: delivering the atmospheric plasma after the cryogenic treatment in a first minute, delivering the atmospheric plasma under the room temperature condition in a second minute, delivering the atmospheric plasma after the cryogenic treatment in a third minute, delivering the atmospheric plasma under the room temperature condition in a fourth minute, and delivering the atmospheric plasma after the cryogenic treatment in a fifth minute. The atmospheric plasma after the cryogenic treatment may be obtained from atmospheric plasma cooled by an ice-water mixture.

The process for delivering plasma at the room temperature and delivering plasma after the cryogenic treatment includes: delivering the plasma through two connecting pipes after the plasma is generated. One of the two connecting pipes is provided at the room temperature to deliver the plasma at the room temperature, and the other connecting pipe passes through the ice-water mixture so that the plasma airflow in the connecting pipe may be cooled down before processing the bayberries.

### Preservation Experiment Test:

### (1) Process:

In the morning, freshly picked Dongkui bayberries were transported back to the laboratory from Xianju, Zhejiang. In the afternoon, the bayberries with no mechanical damage, no mold hyphae on the surface, and similar size and maturity were picked and grouped. In the evening, each experimental group was treated. The control group (CK) was no treated.

Group A: atmospheric plasma treatment was performed for 5 minutes, including: delivering the generated atmospheric plasma into a large sealed box with two pipes connected to the front end of the box and a pipe connected to the rear end. The two pipes at the front end were connected to a device for generating atmospheric plasma, one of the two pipes at the front end was exposed to the room temperature condition, and a section of the other pipe was submerged in an ice-water mixture. The pipe at the rear end was taken out of the door to remove generated ozone. The atmospheric plasma treatment included alternately delivering plasma under the room temperature condition and plasma after a cryogenic treatment, specifically, delivering the plasma after the cryogenic treatment in a first minute, delivering the plasma under the room temperature condition in a second minute, delivering the plasma after the cryogenic treatment in a third minute, delivering the plasma under the room temperature condition in a fourth minute, and delivering the plasma after the cryogenic treatment in a fifth minute. The total treatment time was 5 minutes.

Group B: the bayberries were sprayed with a peroxyacetic acid solution of 0.5% for a total of six times, once each from above, below, front, behind, left, and right of the bayberries, respectively. In the experiment, the bayberries were placed in a skeletonized injection-molded package with 15 grids (shown in FIG. 1). First, the upper section of the package was token away, then the peroxyacetic acid solution was sprayed from above, below, front, behind, left, and right of the skeletonized injection-molded package; then the upper section of the skeletonized injection-molded package was installed and the bayberries were inverted, and the upper section of the skeletonized injection-molded package was disassembled again, and then the peroxyacetic acid solution was sprayed above the skeletonized injection-molded package again. The purpose is to ensure that all six surfaces of each bayberry can be sprayed with the peroxyacetic acid solution.

Group C: after spraying the bayberries with the peroxyacetic acid solution of 0.5% for 6 times, the atmospheric plasma treatment was performed for 5 minutes. The atmospheric plasma treatment was the same as that of group A.

Group D: the bayberries were sprayed with a peroxyacetic acid solution of 0.1% for 6 times, once each from above, below, front, behind, left, and right of the bayberries, respectively.

Group E: after spraying the bayberries with the peroxyacetic acid solution of 0.1% for 6 times, performing the atmospheric plasma treatment for 5 minutes. The atmospheric plasma treatment was the same as that of group A.

All combined treatments involved spraying the peroxyacetic acid solution first and then introducing atmospheric plasma, which was for two main purposes: (1) spraying peroxyacetic acid first would moisten the surface of the bayberries and prevent the bayberries from drying out when introduced into the atmospheric plasma; and (2) spraying peroxyacetic acid first and then introducing atmospheric plasma would decompose the remaining amount of peroxyacetic acid after acting on the bayberries.

The control group and the experimental groups were all stored in the refrigerated warehouse at 4° C., and a total count of colonies was calculated by performing plate counts of microorganisms on days 0, 3, 6, 9, and 12, respectively.

### (2) Result:

### 2.1 Broad-Spectrum Sterilization of Native Microorganisms (Non-Inoculated, Fungi or Yeast Originally on the Fruit Surface)

During the storage period, compared to the control group, the colony counts of all experimental groups were significantly reduced. As shown in Table 1, from the comparison of group A with group C or group A with group E, the combination of the atmospheric plasma and the peroxyacetic acid was more effective than atmospheric plasma alone; from the comparison of group B with group C or group D with group E, the combination of the atmospheric plasma and the peroxyacetic acid was more effective than the peroxyacetic acid alone; from the comparison of group B with group E, the efficacy of the 0.5% peroxyacetic acid solution and the 0.1% peroxyacetic acid solution+atmospheric plasma treatment for five minutes was similar, the colony counts of group B and group E decreased by about 1.8 Lg, which indicated that the atmospheric plasma played a role in the reduction of the peroxyacetic acid solution.

Table 1 shows the colony counts of the control group and each experimental group (CK: untreated bayberry, group A: 5 min-Plasma, group B: 0.5%-peroxyacetic acid, group C: 0.5%-peroxyacetic acid+5 min-Plasma, group D: 0.1%-peroxyacetic acid, group E: 0.1%-peroxyacetic acid+5 min-Plasma), where the Lg value is converted to colony count as 10^{Lg} CFU/g, for example, if the Lg value is 5.7710, then the colony count is 10^{5.7710} CFU/g.

TABLE 1

| | | D0 | D3 | D6 | D9 | D12 |
|---|---|---|---|---|---|---|
| CK | Lg CFU/g | 5.7710 | 5.6666 | 5.5384 | 5.5170 | 5.7571 |
| | Standard | 0.0944 | 0.1836 | 0.1073 | 0.2599 | 0.3665 |
| | deviation | | | | | |
| | Significance | e | c | b | d | c |
| A | Lg CFU/g | 4.7139 | 4.7338 | 4.3944 | 4.5518 | 4.4867 |
| | Standard | 0.0585 | 0.1834 | 0.0913 | 0.1099 | 0.1495 |
| | deviation | | | | | |
| | Significance | d | b | a | bc | ab |
| B | Lg CFU/g | 3.9980 | 4.2035 | 3.9521 | 4.2003 | 4.2762 |
| | Standard | 0.1102 | 0.1030 | 0.3694 | 0.0545 | 0.2657 |
| | deviation | | | | | |
| | Significance | b | a | a | ab | ab |
| C | Lg CFU/g | 3.5659 | 3.8371 | 3.8678 | 3.9184 | 3.7818 |
| | Standard | 0.1549 | 0.1173 | 0.2756 | 0.2572 | 0.2517 |
| | deviation | | | | | |
| | Significance | a | a | a | a | a |
| D | Lg CFU/g | 4.8094 | 4.8432 | 4.4501 | 4.7078 | 4.7133 |
| | Standard | 0.0450 | 0.1673 | 0.1195 | 0.1181 | 0.2536 |
| | deviation | | | | | |
| | Significance | d | b | a | c | b |
| E | Lg CFU/g | 3.8854 | 3.9206 | 3.9309 | 3.9960 | 4.0557 |
| | Standard | 0.0684 | 0.1771 | 0.1023 | 0.0926 | 0.0953 |
| | deviation | | | | | |
| | Significance | ab | a | a | a | ab |

### 2.2 Changes in Weight Loss Rate

In the pre-storage period, the weight loss rates of each experimental group were similar to that of the control group; however, in the post-storage period, the weight loss rates of each experimental group were lower than that of the control group, as shown in Table 2.

From the comparison of group A with group C or group A with group E, the combination of the atmospheric plasma and the peroxyacetic acid was more effective than atmospheric plasma alone. In addition to the consumption of nutrients by respiration, the weight loss of bayberries is also due to the decay and water loss of the fruit caused by microorganisms. Atmospheric plasma and peroxyacetic acid both have the effect of inhibiting the respiration of microorganisms and fruits. in addition, by spraying the peroxyacetic acid solution first during treatment, the surface of the bayberries may be kept moist to prevent the surface from losing water when the atmospheric plasma is introduced.

In the post-storage period, from the comparison of group B with group C or group D with group E, the combination of the atmospheric plasma and the peroxyacetic acid solution was more effective than peroxyacetic acid alone.

Table 2 shows the weight loss rate of the control group and each experimental group (CK: untreated bayberries, group A: 5 min-Plasma, group B: 0.5%-peroxyacetic acid, group C: 0.5%-peroxyacetic acid+5 min-Plasma, group D: 0.1%-peroxyacetic acid, group E: 0.1%-peroxyacetic acid+5 min-Plasma), where the weight loss rate is in %.

| | | D3 | D6 | D9 | D12 |
|---|---|---|---|---|---|
| CK | Weight loss | 0.0493 | 0.0960 | 0.1350 | 0.2077 |
| | rate | | | | |
| | Standard | 0.0040 | 0.0066 | 0.0091 | 0.0105 |
| | deviation | | | | |
| | Significance | a | a | a | b |
| A | Weight loss | 0.0471 | 0.0944 | 0.1321 | 0.1653 |
| | rate | | | | |
| | Standard | 0.0057 | 0.0094 | 0.0114 | 0.0141 |
| | deviation | | | | |
| | Significance | a | a | a | a |
| B | Weight loss | 0.0476 | 0.0839 | 0.1151 | 0.1567 |
| | rate | | | | |
| | Standard | 0.0041 | 0.0071 | 0.0090 | 0.0116 |
| | deviation | | | | |
| | Significance | a | a | a | a |
| C | Weight loss | 0.0420 | 0.0748 | 0.1140 | 0.1397 |
| | rate | | | | |
| | Standard | 0.0038 | 0.0041 | 0.0055 | 0.0084 |
| | deviation | | | | |
| | Significance | a | a | a | a |
| D | Weight loss | 0.0399 | 0.0828 | 0.1279 | 0.1687 |
| | rate | | | | |
| | Standard | 0.0023 | 0.0062 | 0.0092 | 0.0126 |
| | deviation | | | | |
| | Significance | a | a | a | a |
| E | Weight loss | 0.0458 | 0.0762 | 0.1149 | 0.1478 |
| | rate | | | | |
| | Standard | 0.0045 | 0.0053 | 0.0077 | 0.0097 |
| | deviation | | | | |
| | Significance | a | a | a | a |

### 2.3 Changes in Hardness

The hardness of bayberry fruit is easily softened and reduced during storage, mainly because bayberry is susceptible to fungal infection and thus decay. Both atmospheric plasma and peroxyacetic acid can inhibit fungal growth, thereby slowing down fruit softening and maintaining the freshness of the fruit.

During the storage period, the hardness of each experimental group was higher than that of the control group, and the performance was more significant especially in the post-storage period, as shown in table 3.

From the comparison of group A with group C or group A with group E, the combination of the atmospheric plasma and the peroxyacetic acid was more effective than atmospheric plasma alone, especially in the pre-storage period.

From the comparison of group B with group C or group D with group E, the combination of the atmospheric plasma and the peroxyacetic acid was more effective than peroxyacetic acid alone, especially in the pre-storage period.

Table 3 shows the changes in hardness in the control group and each experimental group:

TABLE 3

| | | D0 | D3 | D6 | D9 | D12 |
|---|---|---|---|---|---|---|
| CK | Hardness(N) | 3.7148 | 3.1217 | 2.6810 | 2.3502 | 2.0662 |
| | Standard | 0.1608 | 0.1511 | 0.0165 | 0.0753 | 0.0149 |
| | deviation | | | | | |
| | Significance | a | a | a | a | a |
| A | Hardness(N) | 3.7216 | 3.2716 | 2.9132 | 2.7273 | 2.5226 |
| | Standard | 0.1911 | 0.0499 | 0.0568 | 0.1151 | 0.1688 |
| | deviation | | | | | |
| | Significance | a | abc | ab | ab | b |
| B | Hardness(N) | 3.7029 | 3.2728 | 2.8004 | 2.7592 | 2.4828 |
| | Standard | 0.1566 | 0.0724 | 0.0866 | 0.2164 | 0.0081 |
| | deviation | | | | | |
| | Significance | a | abc | ab | ab | b |
| C | Hardness(N) | 3.7071 | 3.5091 | 3.1269 | 2.7914 | 2.5835 |
| | Standard | 0.1940 | 0.0870 | 0.0690 | 0.1415 | 0.0827 |
| | deviation | | | | | |
| | Significance | a | c | b | b | b |
| D | Hardness(N) | 3.7179 | 3.1897 | 2.7934 | 2.6045 | 2.4690 |
| | Standard | 0.1922 | 0.0698 | 0.1799 | 0.1251 | 0.1618 |
| | deviation | | | | | |
| | Significance | a | ab | ab | ab | b |
| E | Hardness(N) | 3.7155 | 3.4753 | 3.1275 | 2.8381 | 2.5705 |
| | Standard | 0.0590 | 0.1463 | 0.1421 | 0.0848 | 0.0751 |
| | deviation | | | | | |
| | Significance | a | bc | b | b | b |

### Inoculation Experimental Test

Process: In the morning, picked Dongkui high mountain bayberries were transported from Xianju, Zhejiang back to the laboratory, in the afternoon, the bayberries with no mechanical damage, no mold hyphae on the surface, and similar size and maturity were selected and grouped, and in the evening, the grouped bayberries were inoculated with fungi (Penicillium citrinum).

Surface disinfection of the control group and the experimental groups was performed by spraying ethanol of 75%; and the ethanol on the bayberries was volatilized by natural ventilation. A 0.1-mm-deep wound was inflicted on the surface of each bayberry by a sterile stainless steel needle using a point-splicing technology, and 20 μL of a spore suspension containing Penicillium citrinum was inoculated into the bayberry using a pipette.

The inoculated bayberries were processed after drying on a clean workbench for one hour.

The control group (CK) was no treated.

Group A: atmospheric plasma treatment was performed for 5 minutes, including: delivering the generated atmospheric plasma into a large sealed box with two pipes connected to the front end of the box and a pipe connected to the rear end. The two pipes at the front end were connected to a device for generating atmospheric plasma, one of the two pipes at the front end was exposed to the room temperature condition, and a section of the other pipe was submerged in an ice-water mixture. The pipe at the rear end was taken out of the door to remove generated ozone. The atmospheric plasma treatment included alternately delivering plasma under the room temperature condition and plasma after a cryogenic treatment, specifically, delivering the plasma after the cryogenic treatment in a first minute, delivering the plasma under the room temperature condition in a second minute, delivering the plasma after the cryogenic treatment in a third minute, delivering the plasma under the room temperature condition in a fourth minute, and delivering the plasma after the cryogenic treatment in a fifth minute. The total treatment time was 5 minutes.

Group B: the bayberries were sprayed with a peroxyacetic acid solution of 0.5% for a total of six times, once each from above, below, front, behind, left, and right of the bayberries, respectively.

Group C: after spraying the bayberries with the peroxyacetic acid solution of 0.1% for 6 times, the atmospheric plasma treatment was performed for 5 minutes.

The control group and the experimental groups are all stored in the refrigerated warehouse at 20° C., and a total count of colonies is calculated and a decay rate is determined by performing plate counts of microorganisms on days 0, 2, 3, and 4, respectively.

### Result:

compared to the control group, the colony counts of all experimental groups were significantly reduced.

As shown in Table 4, from the comparison of group B with group C, the treatment efficacy of the pre-storage period is similar, which indicates that the atmospheric plasma played a role in the reduction of the peroxyacetic acid solution. In the post-storage period, the colony counts of group C decreased more than that of group B, indicating that the atmospheric plasma played a role in reducing the peroxyacetic acid solution and increasing the treatment efficacy.

From the comparison of group A with group C, there was no significance during the storage period, but the colony counts of group C was lower than that of group A during the storage period, which indicates that the combination of atmospheric plasma and the peroxyacetic acid is more effective than atmospheric plasma alone.

Table 4 shows the count of colonies in each experimental group and the control group after inoculation with fungi (Penicillium citrinum).

TABLE 4

| | | D0 | D2 | D3 | D4 |
|---|---|---|---|---|---|
| CK | Lg CFU/g | 6.7686 | 6.3877 | 6.5809 | 6.7762 |
| | Standard | 0.0710 | 0.1538 | 0.0119 | 0.1556 |
| | deviation | | | | |
| | Significance | b | b | b | b |
| A | Lg CFU/g | 4.6594 | 4.9438 | 5.1943 | 5.5078 |
| | Standard | 0.2068 | 0.1795 | 0.3225 | 0.1427 |
| | deviation | | | | |
| | Significance | a | a | a | a |
| B | Lg CFU/g | 3.9998 | 4.8591 | 5.2761 | 5.2887 |
| | Standard | 0.2614 | 0.1264 | 0.0433 | 0.3386 |
| | deviation | | | | |
| | Significance | a | a | a | a |
| C | Lg CFU/g | 4.0785 | 4.6752 | 4.8895 | 4.6638 |
| | Standard | 0.3800 | 0.0775 | 0.3212 | 0.4385 |
| | deviation | | | | |
| | Significance | a | a | a | a |

### Inoculation Decay Rate:

from the comparison of group A with group C, the decay rate of group C was lower than that of group A during the storage period, which indicates that the combination of the atmospheric plasma and peroxyacetic acid is more effective than atmospheric plasma alone.

As shown in Table 5, from the comparison of group B with group C, the decay rate of group C was lower than that of group B during the storage period, which indicated that the atmospheric plasma played a role in reducing the peroxyacetic acid solution and increasing the treatment efficacy.

Table 5 shows the decay rates of each experimental group and the control group after inoculation with fungi (Penicillium citrinum).

TABLE 5

| | | D2 | D3 | D4 | D5 |
|---|---|---|---|---|---|
| CK | Decay | 23 | 40 | 58 | 75 |
| | rate(%) | | | | |
| | Standard | 1.9245 | 2.7217 | 4.1944 | 5.0000 |
| | deviation | | | | |
| | Significance | b | b | b | b |
| A | Decay | 17 | 23 | 35 | 53 |
| | rate(%) | | | | |
| | Standard | 1.9245 | 2.2222 | 1.9245 | 3.1427 |
| | deviation | | | | |
| | Significance | ab | a | a | a |
| B | Decay | 15 | 23 | 32 | 47 |
| | rate(%) | | | | |
| | Standard | 3.1914 | 4.3033 | 4. 1944 | 2.7217 |
| | deviation | | | | |
| | Significance | ab | a | a | a |
| C | Decay | 15 | 22 | 27 | 43 |
| | rate(%) | | | | |
| | Standard | 1.6667 | 4.1944 | 2.7217 | 3.3333 |
| | deviation | | | | |
| | Significance | a | a | a | a |

### Significance:

The present disclosure can achieve the efficacy of reducing medicine and increasing the treatment efficacy by combining physical technology with chemical preservatives, which can not only effectively reduce the microorganisms (mainly fungi and yeasts) on the surface of bayberry, thereby reducing the decay rate and extending the shelf life of the fruit, but also reduce the amount of chemical preservatives used to achieve green preservation.

The above-described embodiment is only a preferred solution of the present disclosure and does not limit the present disclosure in any form. There are other variations and modifications without exceeding the technical solution described in the claims.

1. A method for reduced-medicine treatment for post-harvest preservation of bayberries, comprising:
(1) packing after picking: placing ripe bayberries into a skeletonized injection-molded package after picking, the bayberries being spaced apart and evenly arranged in the skeletonized injection-molded package;
(2) low-concentration peroxyacetic acid solution treatment: spraying a peroxyacetic acid solution with a concentration of 0.1% onto a surface of the bayberries; and
(3) atmospheric plasma treatment: performing an atmospheric plasma treatment on the bayberries treated with the peroxyacetic acid solution for 5 minutes, and temporarily storing the bayberries in a refrigerated warehouse at 4° C. after the treatment;
wherein in step (3), the atmospheric plasma treatment includes alternately delivering atmospheric plasma under a room temperature condition and atmospheric plasma after a cryogenic treatment, including: delivering the atmospheric plasma after the cryogenic treatment in a first minute, delivering the atmospheric plasma under the room temperature condition in a second minute, delivering the atmospheric plasma after the cryogenic treatment in a third minute, delivering the atmospheric plasma under the room temperature condition in a fourth minute, and delivering the atmospheric plasma after the cryogenic treatment in a fifth minute; and the atmospheric plasma after the cryogenic treatment is obtained from atmospheric plasma cooled by an ice-water mixture.

2. The method of claim 1, wherein in step (2), the bayberries are sprayed with the peroxyacetic acid solution for a total of 6 times, once each from above, below, front, behind, left, and right of the bayberries, respectively.

3. The method of claim 1, wherein in step (3), the atmospheric plasma is plasma generated by injecting air as a working gas with a gas flow rate of 1.05 m³/min into an electrode tube in a discharge gap of 0.3 mm.

4. (canceled)
